(19) United States
(12) Patent Application Publication
(10) Pub. No.: US 2025/0272832 A1
(43) Pub. Date: Aug. 28, 2025

(54) SYSTEMS FOR INSECT MORTALITY ASSESSMENT, AND RELATED METHODS

(71) Applicant: Monsanto Technology LLC, St. Louis, MO (US)

(72) Inventors: Nima Hamidi Ghalehjegh, St. Louis, MO (US); Seyed Vahid Mirnezami, St. Louis, MO (US); Lawery Steven Johnson, St. Louis, MO (US); Matthew R. Walters, St. Louis, MO (US); Terry Bradshaw, St. Louis, MO (US)

(21) Appl. No.: 19/053,909

(22) Filed: Feb. 14, 2025

Related U.S. Application Data
(60) Provisional application No. 63/556,969, filed on Feb. 23, 2024.

(51) Int. Cl. G06T 7/00; G06V 10/764; G06V 10/774; G06V 10/82

(52) U.S. Cl. CPC G06T 7/0012; G06V 10/764; G06V 10/774; G06V 10/82; G06T 2207/20081; G06T 2207/20084

(57) ABSTRACT

A system is provided for insect mortality assessment. In one example, the system includes one or more cameras and a removable plate located a predetermined distance from the cameras. The removable plate has a well in which an insect specimen is disposed. A memory stores instructions that, when executed by a processor, cause the processor to transmit one or more signals to the one or more cameras to capture a plurality of time-series images of the insect specimen and pre-process the time-series images of the insect specimen. The instructions further cause the system to analyze, using a trained Siamese neural network, the time-series images of the insect specimen to determine vitality status of the insect specimen, and store results indicating the vitality status of the insect specimen in the memory.

### CROSS-REFERENCE TO RELATED APPLICATION

The present application claims the benefit of U.S. Provisional Patent Application No. 63/556,969, filed Feb. 23, 2024, the disclosure of which is hereby incorporated by reference in its entirety.

### FIELD

The present disclosure generally relates to systems and methods for automatically differentiating between living insect specimens and non-living insect specimens. Also disclosed are systems and methods for insect mortality assessment.

### BACKGROUND

This section provides background information related to the present disclosure which is not necessarily prior art.

In agriculture, and in crop protection more specifically, it is known for the efficacy of pesticides to be tested against target pests. For example, during insecticide discovery or development, it may be necessary to test the insecticidal properties of a plurality of compounds of interest against target insects in a controlled/laboratory environment. Such evaluation of insecticidal properties often includes performing a mortality assessment of exposed insects, which in turn requires differentiating between living and non-living/dead insect specimens. Differentiating between living and dead insect specimens is often image-based, but may be time-consuming and error prone. Automated image-based mortality assessments may be performed which may be more efficient and accurate, and therefore enable insecticide discovery to advance at a more rapid pace.

### SUMMARY

This section provides a general summary of the disclosure, and is not a comprehensive disclosure of its full scope or all of its features.

Example embodiments of the present disclosure generally relate to systems for detecting insect mortality. In one example embodiment, such a system generally includes one or more cameras and a removable plate located a predetermined distance from the one or more cameras. The removable plate has a well in which an insect specimen is disposed. The example system further includes a processor and a memory storing instructions that, when executed by the processor, cause the processor to transmit one or more signals to the one or more cameras to capture at least two time-series images of the insect specimen and pre-process the at least two time-series images of the insect specimen. The instructions further cause the system to analyze, using a trained Siamese neural network, the at least two time-series images of the insect specimen to determine vitality status of the insect specimen, and store results indicating the vitality status of the insect specimen in the memory.

Example embodiments of the present disclosure also generally relate to methods of detecting insect mortality. In one example embodiment, such a method generally includes removing a removable plate located a predetermined distance from one or more cameras, the removable plate having a well in which an insect specimen is disposed. The example method further includes transmitting one or more signals to the one or more cameras to capture at least two time-series images of the insect specimen and pre-processing the at least two time-series images of the insect specimen. The example method further includes analyzing, using a trained Siamese neural network, the at least two time-series images of the insect specimen to determine vitality status of the insect specimen, and storing results indicating the vitality status of the insect specimen in a memory coupled to a processor.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is an example embodiment of a system for detecting insect mortality;

FIG. 2 shows example time-series images of an insect specimen;

FIG. 3 shows an example method of detecting insect mortality according to the prior art;

FIG. 4 is an is an example embodiment of a method for detecting insect mortality;

FIG. 5 shows datasets used in an example embodiment of the system of the present disclosure;

FIG. 6 shows data generated using the system of the present disclosure and demonstrating an accuracy of the system;

FIG. 7 shows confusion matrices associated with data generated using the system of the present disclosure;

FIG. 8 illustrates an example configuration of a computing device that may be used with the system shown in FIG. 1;

FIG. 9 is a flowchart of an example process for detecting insect mortality.

### DETAILED DESCRIPTION

Example embodiments will now be described more fully with reference to the accompanying drawings. The description and specific examples included herein are intended for purposes of illustration only and are not intended to limit the scope of the present disclosure.

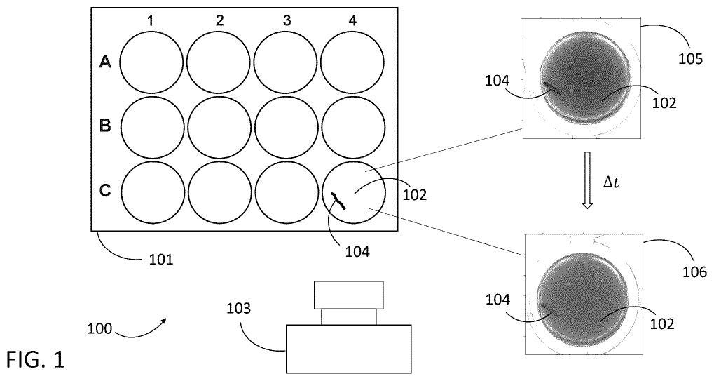

FIG. 1 shows an example system 100 for differentiating between living and non-living insect specimens. Example system 100 generally includes a well plate 101, which in the example embodiment is a 12-well plate. In other embodiments well plate 101 may be 6-well plate, a 24-well plate, or may include any number of wells or receptacles that enable example system 100 to function as described herein. Well plate 101 includes an occupied well 102 containing an insect specimen 104 surrounded by a liquid medium. The liquid medium may include a candidate insecticide being tested for insecticidal efficacy against insect specimen 104. The liquid medium may include other components, for example water, nutrients, pH buffers, etc. In connection with certain control and/or comparison experiments, the liquid medium may not include an insecticide. In other embodiments, the occupied well 102 may contain a gel instead of or in addition to a liquid medium.

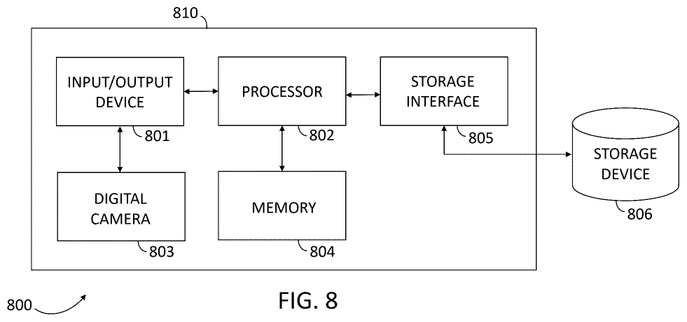

Example system 100 further includes a camera 103 configured to collect images of well plate 101. Images of well plate 101 may include substantially all of well plate 101 or may include portions of well plate 101 (e.g. individual wells of well plate 101). In the example embodiment, camera 103 is a digital camera. In some embodiments, system 100 includes a plurality of cameras 103. In some embodiments, camera 103 is operatively couple to, or incorporated with, a computing device, for example computing device 810 shown in FIG. 8.

FIG. 1 also shows an example first image 105 of occupied well 102 taken at a time t₀ using camera 103. Within first image 105 is an image of insect specimen 104. In some embodiments, system 100 may include a memory for storing digital images collected from camera 103. Stored digital images may be analyzed to characterize, for example, the size, morphology, and/or position of insect specimen 104 within occupied well 102 at t₀. FIG. 1 also shows an example second image 106 of occupied well 102 taken at a later time t₀+Δt. Similar to first image 105, second image 106 may be stored in a memory and analyzed to characterize insect specimen 104 within occupied well 102 at t₀+Δt.

In general, a comparison between first image 105 and second image 106 may provide information regarding the vital status of insect specimen 104. For example, the position of insect specimen 104 in each of example images 105 and 106 may indicate a loss of motility that may further indicate insect specimen 104 is dead. Such a mortality assessment may be used to determine the pesticidal efficacy of the insecticide present in the liquid medium to which insect specimen 104 was exposed. In this example, it may be concluded that the pesticidal efficacy of the insecticide present in the liquid medium is sufficient against insect specimen 104.

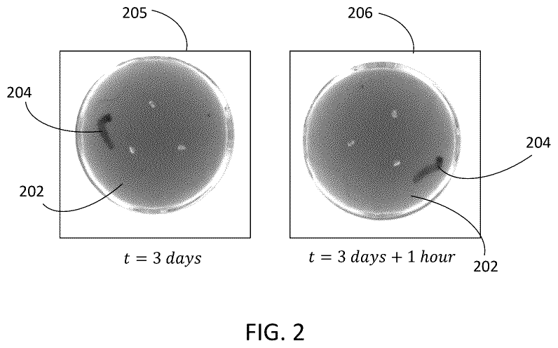

FIG. 2 shows another example first image 205 and example second image 206. First image 205 was collected after an insect specimen 204 was placed in a well 202 filled with liquid medium. In this example, the liquid medium in well 202 includes an insecticide. Insect specimen 204 was allowed to remain in the well for 3 days prior to collection of first image 205. Second image 206 of well 202 was collected an hour after first image 205 was collected. A comparison of first image 205 and second image 206 may be used to perform a mortality assessment of insect specimen 204. For example, it may be observed that insect specimen 204 appears to have moved from the left half of well 202 to the right half of well 202 between collection of first image 205 and second image 206. This apparent motility may indicate vitality of insect specimen 204 and lead an observer to conclude that insect specimen 204 is alive. As before with respect to FIG. 1, such a mortality assessment may be used to determine the pesticidal efficacy of an insecticide present in the liquid medium to which insect specimen 204 was exposed. In this example, it may be concluded that the pesticidal efficacy of an insecticide present in the liquid medium is insufficient against insect specimen 104.

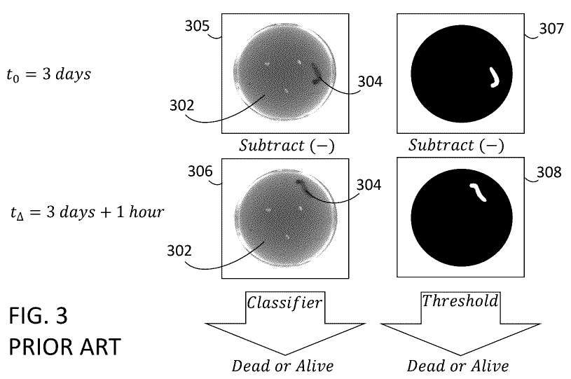

FIG. 3 shows an example mortality assessment process as disclosed in the prior art. First image 305 was collected after an insect specimen 304 was placed in a well 302 filled with liquid medium. The liquid medium in well 302 may or may not include an insecticide. Insect specimen 304 was allowed to remain in the well for 3 days prior to collection of first image 305. Second image 306 of well 302 was collected an hour after first image 305 was collected. Images 305 and 306 may be compared visually to make a mortality assessment. Alternatively, an assessment may be made automatically with the aid of a computer algorithm in combination with a trained dataset. For example, an algorithm could be used to perform an image subtraction on images 305 and 306, and a corresponding classifier trained on the trained dataset could be used to assign a “dead” or “alive” status on insect specimen 304.

With further reference to FIG. 3, images 305 and 306 may be processed whereby a digital value may be assigned for each pixel in each of images 305 and 306. For example, an algorithm may be trained and used to differentiate between pixels associated with insect specimen 304 and pixels associated with the surrounding medium (i.e., not associated with insect specimen 304). Such an algorithm may be referred to as a masking algorithm. Image 307 was derived from image 305 and generated by, for example, assigning a “1” to each pixel associated with insect specimen 304 and a “0” to each pixel associated with the surrounding medium. Image 308 was generated similarly with image 306 as input. The algorithm may then compare corresponding pixels of images 307 and 308 and assign a further value for each pair of corresponding pixels. For example, a value of “0” could be assigned to each pair or corresponding pixels that are equal in value (i.e. both 0 or 1), and a value of “1” could be assigned to each pair or corresponding pixels that are not equal in value. A sum could then be calculated including all the pairs of pixels and the value of that sum could be compared to a threshold value and used to make a mortality assessment. For example, comparing images 307 and 308 as described above would produce a sum greater than zero since there are a number of pairs of corresponding pixels comprising pixels assigned different values. If the sum was sufficiently larger than some threshold distance from zero the algorithm may label insect specimen 304 alive. Conversely, an insufficient sum may cause the algorithm to label insect specimen 304 dead. However, the prior art methods described above have numerous shortcomings. For example, such methods generally are not robust against changes in lighting conditions. That is, in one instance, the lighting conditions of image 307 may be slightly different than the lighting conditions of image 308, due to, for example, a slight change in angle between the camera 103 and the well 102. In another instance, the image 307 may be brighter than the image 308 or vice versa due to external environmental factors. This may cause corresponding pixels in images 307 and 308 to have different values after the masking step when they should be the same, which may generate a false positive result (e.g. the algorithm mistakenly determining that the insect specimen is alive when it is actually dead). Similar issues may arise when the well 102 is shifted by a certain distance between when images 307 and 308 are captured. Therefore, a more robust algorithm for determining insect mortality is needed in the art.

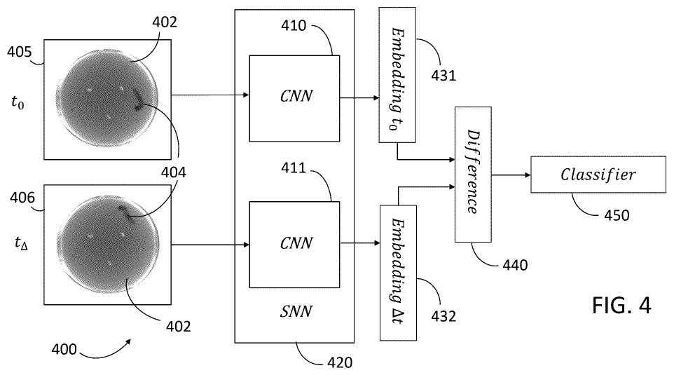

FIG. 4 is an is an example embodiment of a method 400 for detecting insect mortality and may be implemented using system 100 in combination with computing device 810, shown in FIG. 8. First image 405 was collected at time t₀ after an insect specimen 404 was placed in a well 402 filled with liquid medium. The liquid medium in well 402 may or may not include an insecticide. Insect specimen 404 was allowed to remain in the well for a period of time (for example 3 days) prior to collection of first image 405. Second image 406 of well 402 is collected at time t_{Δ} after first image 405 was collected. In some embodiments, time t_{Δ} is 0.5, 1.0, 2.0, 3.0, 10, 24, or 48 hours after time t₀. In some embodiments, first image 405 and second image 406 are two of a set of more than two time-series images. For example, multiple images may be collected at each of t₀ and t_{Δ}, and images may be collected at time points other than t₀ and t_{Δ}.

In some embodiments, first image 405 and second image 406 may be pre-processed. Pre-processing may include removing outside edges of digital images 405 and 406 not including portions of the insect specimen, or removing extraneous visual data (i.e. image cropping). In other embodiments, pre-processing may include changing an aspect ratio of digital images 405 and 406, magnification, isolation of portions of the images, or any other process that enables the method to be carried out as described herein.

First image 405 is analyzed by a Siamese neural network (SNN) 420. In the example embodiment, SNN 420 is a trained neural network trained on a first set of images of live specimens and a second set of images of dead specimens. In some embodiments, images of live specimens are over-sampled as compared to images of dead specimens. In some embodiments, images of dead specimens are over-sampled, and in some embodiments images of live and dead specimens are sampled about equally. SNN 420 may be retrained as new or more digital images, or data derived therefrom, become available.

In some embodiments, the first set of images of live specimens includes one or more original images of the live specimens and an augmented data set. The augmented data set may be generated by modifying the one or more original images of the live specimens. In one embodiment, the modification may be shifting the pixels in the one or more original images of the live specimens by a predetermined distance. For example, in each original image, each pixel may be shifted leftward by 5 pixels. In another embodiment, the augmented data set may be generated by modifying the lighting conditions of the one or more original images (e.g. increasing the brightness of the images).

In the example embodiment, SNN 420 includes two convolutional neural networks (CNNs), including CNN 410. SNN 420 may also be referred to as a twin neural network. CNN 410 is configured to analyze digital images, more specifically to extract features from digital images to feed into statistical models. In some embodiments, CNN 410 is a feed-forward neural network, is a fully connected neural network, and may include any number of layers and kernels enabling CNN 410 to function as described herein. CNN 410 may also include any number of neurons and weights for each neuron in a given layer such that CNN 410 is able to function as described herein. In some embodiments, CNN 410 is a ResNet50 network.

Second image 406 is also analyzed by SNN 420 in a manner similar to first image 405. More specifically, second image 406 is processed using a CNN 411 that is similar to CNN 410. For example, CNN 410 and CNN 411 may use the same weights, and may share other features in common. In some embodiments, CNN 411 is a ResNet50 network. In some embodiments, CNN 410 and CNN 411 are substantially identical, and may be substantially identical ResNet50 networks. In this instance, in order to be “substantially identical,” CNN 410 and CNN 411 are sufficiently identical so as to enable the accurate determination of insect specimen mortality as disclosed herein.

Using trained SNN 420, an embedding 431 is generated for first image 405 and a separate embedding 432 is generated for second image 406. In general, a set of embeddings is generated by the trained SNN 420, each embedding uniquely corresponding to one time-series image of insect specimen 404. In the example embodiment, embedding refers to a process of mapping categorical variables to numbers making up a vector. Embedding may therefore reduce a dimensionality of the categorical variables. Embedding dimension may be chosen or altered based on performance of method 400.

With further reference to FIG. 4, a difference 440 between embeddings 431 and 432 is calculated. In combination with a classifier layer 450, difference 440 may be used to determine a vitality status of insect specimen 404. In some embodiments, classifier layer 450 is a sigmoid classifier layer. In some embodiments, classifier layer 450 is a logistical classifier layer.

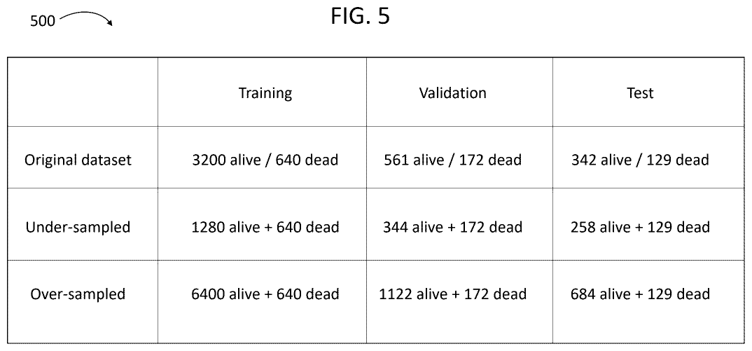

FIG. 5 shows datasets used in an example embodiment of the system of the present disclosure. As part of experimenting with the method and algorithm shown in FIG. 4, the SNN 420 is trained in three separate instances on three different datasets, as shown in FIG. 5. For example, in the first experiment, an original dataset of 3,200 images of alive specimens and 640 images of dead specimens is used to train the SNN 420. The resulting trained model is validated against 561 images of alive specimens and 172 images of dead specimens. And finally, after validation, the trained model is tested on 342 images of alive specimens and 129 images of dead specimens. In alternative experiments, the images of alive specimens are under-sampled and over-sampled. In the under-sampled experiment, 1,280 images of alive specimens are used. In the over-sampled experiment, 6,400 images of alive specimens are used. For this particular embodiment of the present disclosure, it was found that the model trained on the over-sampled dataset performed better.

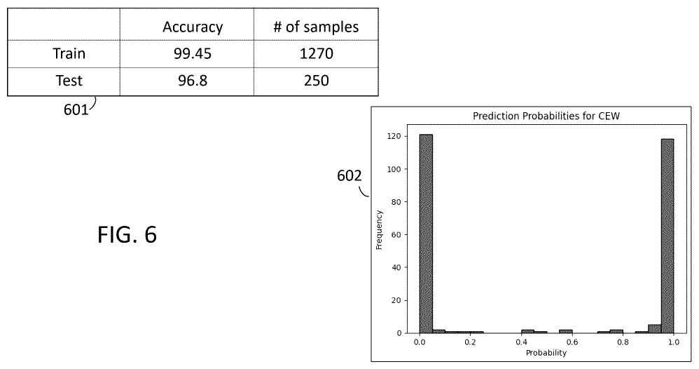

FIG. 6 shows data generated using the system of the present disclosure and demonstrating an accuracy of the system, including data table 601 and corresponding bar graph 602. As shown in data table 601, training data was analyzed using the method of the present disclosure, for example the method shown in FIG. 4. More specifically, mortality assessment was performed on 1,270 training samples. The assessment correctly assessed the mortality status of 1,263 of the samples and incorrectly assessed 7 (seven) of the samples, corresponding to a 99.45% accuracy rate.

As also shown in data table 601, test data was analyzed using the method of the present disclosure, for example the method shown in FIG. 4. More specifically, mortality assessment was performed on 250 test samples. The assessment correctly assessed the mortality status of 242 of the samples and incorrectly assessed 8 (eight) of the samples, corresponding to a 96.8% accuracy rate.

Data associated with the test samples are also shown graphically in bar graph 602. More specifically, bar graph 602 is a histogram showing the total number of test samples assigned a given probability of being alive. For example, about 120 samples were assigned a probability of 95-100% of being alive and about 120 samples were assigned a probability of 95-100% of being dead. However, a relatively small number were assigned an intermediate probability of being either dead or alive. Intermediate probabilities are associated with a relatively low level of certainty or confidence in the accuracy of the mortality assessment. The data in table 601 and bar graph 602 indicate that the present method is capable of generating, for example, a logistical regression model of insect mortality with high predictive ability.

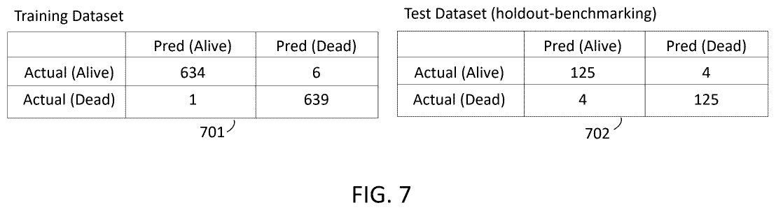

FIG. 7 shows confusion matrices associated with the data shown in FIG. 6. Table 701 shows data derived from the training data. Analysis of the training data correctly predicted 634 insect samples as alive and correctly predicted 639 insect samples as dead. Six living insect samples were incorrectly predicted to be dead, and one sample of a dead insect was incorrectly predicted to be alive. Table 702 shows data derived from the test data. Analysis of the test data correctly predicted 125 insect samples as alive and correctly predicted 125 insect samples as dead. Four living insect samples were incorrectly predicted to be dead, and four dead insect samples were incorrectly predicted to be alive.

FIG. 8 illustrates an example configuration 800 of a computing device 810 that maybe used with the system shown in FIG. 1. Computing device 810 includes a processor 802 for executing instructions. Instructions may be stored in a memory area 804, for example. Processor 802 may include one or more processing units (e.g., in a multi-core configuration).

Processor 802 is operatively coupled to an input/output device 801 such that computing device 810 is capable of communicating with a user such as a lab worker or scientific investigator. For example, input/output device 801 may receive and transmit instructions from the user to carry out the method above. In some embodiments, computing device 810 is capable of communicating with a user remote device, such as a mobile tablet or smartphone, and may receive and transmit instructions via a network.

Input/output device 801 is operatively coupled to a digital camera 803. Digital camera 803 is configured to capture digital images of insect specimens for mortality assessments as described herein. For example, digital camera 803 may be incorporated into system 100 as shown in FIG. 1. Digital camera 803 is further configured to transmit data associated with captured digital images to input/output device 801. Processor 802 may receive such data from input/output device 801 and perform an analytical method on the data, for example the method shown in FIG. 4. In some embodiments, digital camera 803 communicates directly with processor 802. and may include an internal storage device.

Processor 802 may also be operatively coupled to a storage device 806. Storage device 806 is any computer-operated hardware suitable for storing and/or retrieving data. In some embodiments, storage device 806 is integrated in computing device 810. For example, computing device 810 may include one or more hard disk drives as storage device 806. In other embodiments, storage device 806 is external to computing device 810 and may be accessed by a plurality of server computer devices. For example, storage device 806 may include multiple storage units such as hard disks or solid state disks in a redundant array of inexpensive disks (RAID) configuration. Storage device 806 may include a storage area network (SAN) and/or a network attached storage (NAS) system.

In some embodiments. processor 802 is operatively coupled to storage device 806 via a storage interface 805. Storage interface 805 is any component capable of providing processor 802 with access to storage device 806. Storage interface 805 may include. for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 802 with access to storage device 806.

Memory area 804 may include, but are not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only, and are thus not limiting as to the types of memory usable for storage of a computer program.

The term processor, as used herein, refers to central processing units, microprocessors, microcontrollers, reduced instruction set circuits (RISC), application specific integrated circuits (ASIC), logic circuits, and any other circuit or processor capable of executing the functions described herein.

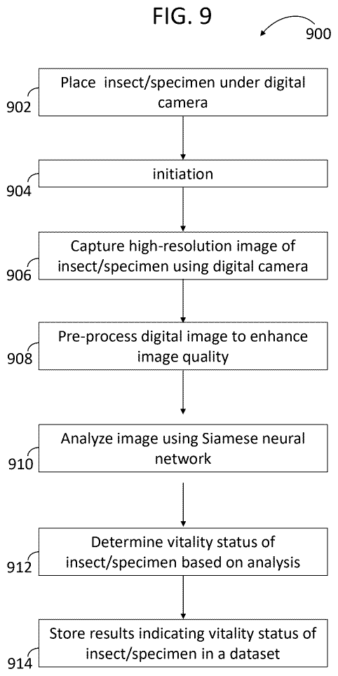

FIG. 9 is a is a flowchart of an example method 900 for detecting insect mortality. In the example embodiment, portions of method 900 may be performed by a system for detecting insect mortality, such as system 100 (shown in FIG. 1). In certain embodiments. portions of method 900 may be performed in combination a computing device. In other embodiments. method 900 may include additional, fewer, or alternative actions, including those described elsewhere herein.

Method 900 begins with placing 902 a specimen, for example an insect specimen, under a digital camera. In some embodiments, the insect specimen may be contained within a well of a well plate and surrounded by a liquid medium. The system may then be initiated in step 904. Initiation may include the step of aligning the lens of the digital camera with the well of the well plate. After initiation 904, the digital camera captures 906 a digital image of the insect specimen. In some embodiments the digital camera will capture 906 a plurality of digital images. The digital image may then undergo a pre-process 908 step. In some embodiments, pre-process step 908 may include removing outside edges of the digital image not including portions of the insect specimen, or to removing extraneous visual data (i.e. image cropping). In other embodiments, pre-process step 908 may include changing an aspect ratio of the digital image, magnification, isolation of portions of the image, or any other process that enables the method to be carried out as described herein. The digital image is then analyzed 910 using a Siamese neural network and comparing the analyzed image to a trained dataset. A vitality status of the insect specimen is then determined 912. Results indicating the vitality status of the insect specimen are then stored 914 in a dataset. In some embodiments, the results in stored in the dataset may used to further train the dataset in 910 for analysis of other digital images.

The above written description uses examples to describe embodiments of the disclosure, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A system for automatically detecting insect mortality, the system comprising:
one or more cameras;
a removable plate located a predetermined distance from the one or more cameras, the removable plate having a well in which an insect specimen is disposed;
a processor; and
a memory storing instructions that, when executed by the processor, cause the processor to:
transmit one or more signals to the one or more cameras to capture at least two time-series images of the insect specimen;
pre-process the at least two time-series images of the insect specimen;
using a trained Siamese neural network, analyze the at least two time-series images of the insect specimen to determine vitality status of the insect specimen; and
store results indicating the vitality status of the insect specimen in the memory.

2. The system of claim 1, wherein to pre-process the at least two time-series images of the insect specimen, the memory further stores instructions that, when executed by the processor, cause the processor to crop each of the at least two time-series images of the insect specimen.

3. The system of claim 1, wherein the trained Siamese neural network comprises two convolutional neural networks.

4. The system of claim 3, wherein the two convolutional neural networks are ResNet50 networks.

5. The system of claim 1, wherein to analyze the at least two time-series images of the insect specimen, the memory further stores instructions that, when executed by the processor, cause the processor to:
use the trained Siamese neural network to generate at least two sets of embeddings, each set of embeddings uniquely corresponding to one of the at least two time-series images of the insect specimen;
calculate a difference between the at least two sets of embeddings; and
determine the vitality status of the insect specimen based on the difference between the at least two sets of embeddings and a classifier layer.

6. The system of claim 5, wherein the classifier layer is a sigmoid classifier layer.

7. The system of claim 1, wherein the trained Siamese neural network is trained on a first set of images of live specimens and a second set of images of dead specimens, and wherein the first set of images is over-sampled as compared to the second set of images.

8. The system of claim 7, wherein the first set of images of live specimens comprises:
one or more original images of the live specimens; and
an augmented data set generated by modifying the one or more original images of the live specimens.

9. A method for automatically detecting insect mortality, the method comprising:
removing a removable plate located a predetermined distance from one or more cameras, the removable plate having a well in which an insect specimen is disposed;
transmitting one or more signals to the one or more cameras to capture at least two time-series images of the insect specimen;
pre-processing the at least two time-series images of the insect specimen;
analyzing, using a trained Siamese neural network, the at least two time-series images of the insect specimen to determine vitality status of the insect specimen; and
storing results indicating the vitality status of the insect specimen in a memory coupled to a processor.

10. The method of claim 9, wherein pre-processing the at least two time-series images of the insect specimen comprises cropping each of the at least two time-series images of the insect specimen.

11. The method of claim 9, wherein the trained Siamese neural network comprises two convolutional neural networks.

12. The method of claim 11, wherein the two convolutional neural networks are ResNet50 networks.

13. The method of claim 9, wherein analyzing the at least two time-series images of the insect specimen comprises:
using the trained Siamese neural network to generate at least two sets of embeddings, each set of embeddings uniquely corresponding to one of the at least two time-series images of the insect specimen;
calculating a difference between the at least two sets of embeddings; and
determining the vitality status of the insect specimen based on the difference between the at least two sets of embeddings and a classifier layer.

14. The method of claim 13, wherein the classifier layer is a sigmoid classifier layer.

15. The method of claim 9, wherein the trained Siamese neural network is trained on a first set of images of live specimens and a second set of images of dead specimens, and wherein the first set of images is over-sampled as compared to the second set of images.

16. The method of claim 15, wherein the first set of images of live specimens comprises:
one or more original images of the live specimens; and
an augmented data set generated by modifying the one or more original images of the live specimens.
